(19) United States
(12) Patent Application Publication
(10) Pub. No.: US 2026/0361838 A1
(43) Pub. Date: Nov. 12, 2026

(54) TILEABLE IMAGE PROJECTOR ARRAY

(71) Applicant: U.S. Army DEVCOM, Army Research Laboratory, Adelphi, MD (US)

(72) Inventors: Patrick W. Jungwirth, Abingdon, MD (US); W. Michael Crowe, Madison, AL (US)

(73) Assignee: U.S. Government, as Represented by the Secretary of the Army, Adelphi, MD (US)

(21) Appl. No.: 19/200,209

(22) Filed: May 6, 2025

(51) Int. Cl. H04N 9/31; G02B 1/11

(52) U.S. Cl. CPC H04N 9/3147; G02B 1/11; H04N 9/3105; H04N 9/317

(57) ABSTRACT

We present a low cost, extendable, image projector array. An input image is partitioned into a plurality of sub-images which when fed into projector arrays formed of one or more spaced-apart projector elements, and using at least one beam splitter creates a composite image substantially corresponding to the input image. A mirroring means (physical mirror or electronic/digital mirroring algorithm) is provided to reconcile image orientation due to operation of the beam splitter. The positions of the one or more projector elements in one projector arrays, when factoring in the effect of the mirror means, generally correspond to spaces between or adjacent the one or more projector elements in another projector array when their respective projected sub-images are superimposed and aligned to project the image. A slight overlap (e.g., up to 20%) of sub-images, based on positions of the projector elements, allow for the sub-images to combine to create a very high-resolution composite image. A set of projectors arrays consisting of 6×6×4 projector elements could create an 850-million-pixel resolution image. Other applications include image projections for areal mapping, surveillance systems, imaging satellites, and medical imaging.

### RELATED APPLICATION

This application is related to U.S. patent application Ser. No. 19/064,226 filed Feb. 26, 2025 and titled “Tileable Image Sensor Array” (Docket No. ARL 24-06), having the same inventors, which is herein incorporated by reference in its entirety. That application introduced similar concepts as described herein.

### GOVERNMENT INTEREST

The invention described herein may be manufactured, used and licensed by or for the U.S. Government.

### BACKGROUND

### Field

Embodiments of the present invention are directed to image projectors and, more particularly to a tileable image projector array.

### Description of the Related Art

Projectors having a very large number of pixels are increasingly in demand. The very large number of pixels provide greater image resolution and larger imaging capability. However, the costs to manufacture large projectors, for instance, more than 1 gigapixels, are costly due to defects which reduce the quality of the projector elements. Significant defects are rejected in Quality Assurance (QA) Quality Control (QC) processes in the projector element production line. The greater number of pixels per projector element increases the risk of defects.

In light of the foregoing, improvements for projectors are desired.

### SUMMARY

We introduce a low-cost tileable image projector array using low-cost optical components, and low cost (non-higher precision) assembly methods. It includes one or more projector arrays having one or more projector elements positioned adjacent to the sides of at least one beam splitter. An input image is partitioned into a plurality of sub-images which when are to be projected by the various projector elements of the projector arrays. The image projector provides multiple unique optical paths for sub-images projected by the various projector elements to be combined by the at least one beam splitter to form a composite image substantially corresponding to the input image. A mirroring means (i.e., physical mirror or electronic/digital mirroring algorithm) is provided to reconcile image orientation due to the internal operation of the at least one beam splitter. The positions of the one or more projector elements in one projector arrays, when factoring in the effect of the mirror means, generally correspond to spaces between or adjacent the one or more projector elements in another projector array when their respective projected sub-images are superimposed and aligned to project the image. A slight overlap (e.g., up to 20%) of sub-images, based on positions of the projector elements or through digital means, allows for the sub-images to combine together to create a very high-resolution composite image; however, this requires reducing the pixel intensity of the overlapping regions which will combine. Ideally, the various sub-images completely cover the image plane when factoring in the mirroring means. We also present calibration techniques.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments, including less effective but also less expensive embodiments which for some applications may be preferred when funds are limited. These embodiments are intended to be included within the following description and protected by the accompanying claims.

FIG. 1 illustrates a single beam splitter projector array system.

FIG. 2 shows a 3-dimensional view with light rays propagating through a single beam splitter.

FIG. 3 shows a single beam splitter implementation of the present invention.

FIG. 4 compares an image to a mirrored image.

FIG. 5 illustrates a mirroring method to correct for the beam splitter mirroring beam path 2 (reflected beam path).

FIG. 6 shows an image processor to digitally mirror to correct for beam path 2 (reflected beam path).

FIG. 7 describes the image processor splitting the input image to create sub-images image which are to be projected by each projector array to create a composite output image.

FIG. 8 shows a 3-dimensional view of the projector arrays, projector elements thereof, light ray paths, and output composite image.

FIG. 9 focuses on the projector arrays, and projector elements thereof for the single beam splitter example of the present invention.

FIG. 10 illustrates the positions of the projector arrays and projector elements thereof for an example single beam splitter.

FIG. 11 illustrates the spacing of the projector elements of the arrays and their overlapping images.

FIGS. 12A-12E illustrate examples of splitting an input image into overlapping sub-images for the projector arrays (based on positions of the projector elements in FIGS. 12A-12D, and through digital means in FIG. 12E) to project a composite image using a single beam splitter.

FIG. 13 presents a computer algorithm to process an input image in order for the projector array system to output a composite output image.

FIG. 14 presents a three-beam splitter version of the present invention. The 2-dimensional figure shows an input image converted to a composite output image.

FIG. 15 shows a 3-dimensional view where four projector array planes are combined to create an output composite image.

FIG. 16 shows projector arrays 1, 2M, 3, and 4M combine together to create a composite image.

FIG. 17 shows an example projector array for a 4×4×4 array of projector elements.

FIG. 18 illustrates how an input image is split into sub-images to be projected by overlapping projector elements for the 4×4×4 array in FIG. 17.

FIG. 19 uses multiple wavelengths to create a composite image for the present invention.

FIG. 20 shows an example optical assembly according to embodiments of the present invention.

FIG. 21 shows the anti-reflection coatings and optical baffles according to embodiments of the present invention.

FIG. 22 shows the anti-reflection coatings and optical baffles for the projector arrays.

FIG. 23 shows the calibration data sets for the present invention.

FIG. 24 illustrates splitting an input image into sub-images to be projected with the projector arrays to create a composite image using the present invention.

FIG. 25 shows the projected sub-images fed into the three-beam splitter of the present invention to create a composite image.

FIG. 26 depicts the computer algorithm to process an input image in order for the projector array system to output a composite output image.

### DETAILED DESCRIPTION

The present invention provides a low cost, extendable, image projector array. It includes at least one beam splitter, projector arrays of projector elements and a mirroring means (physical mirror or electronic/digital mirroring algorithm). An input image is partitioned into multiple sub-images which are fed to the projector arrays which are formed of one or more spaced apart projector elements. The positions of the individual projector elements in one of the pair of projector arrays, when factoring in the effect of the mirror means, generally correspond to spaces among, between or adjacent the projector elements in the other of the pair of projector arrays in the first direction when their respective projected sub-images are superimposed and aligned to project the image. The at least one beam splitter takes the various projections from the projector arrays and optically combines them to generate and output a composite image. Ideally, projection of a composite image which fully corresponds to the input image is sought.

With a 2560×2560 pixel resolution for each projector element, an array of 3×3×4 projector elements will create a 210-million-pixel resolution composite image. An array of 6×6×4 of these projector elements could create an 850-million-pixel resolution image. (For reference, the human eye has approximately 576-million-pixel resolution). A slight overlap (e.g., up to 20%) of the sub-images of image projector elements allow for the projected sub-images to combine to create a very high-resolution composite image. The overlap may be produced by the placement of the projector elements or digitally. This projector technology may be beneficial to create a fully digital projection system with IMAX® level of resolution (approximately 12,000×12,000 pixels equals 144 million pixels). Other applications include image projections for areal mapping, surveillance systems, imaging satellites, and medical imaging.

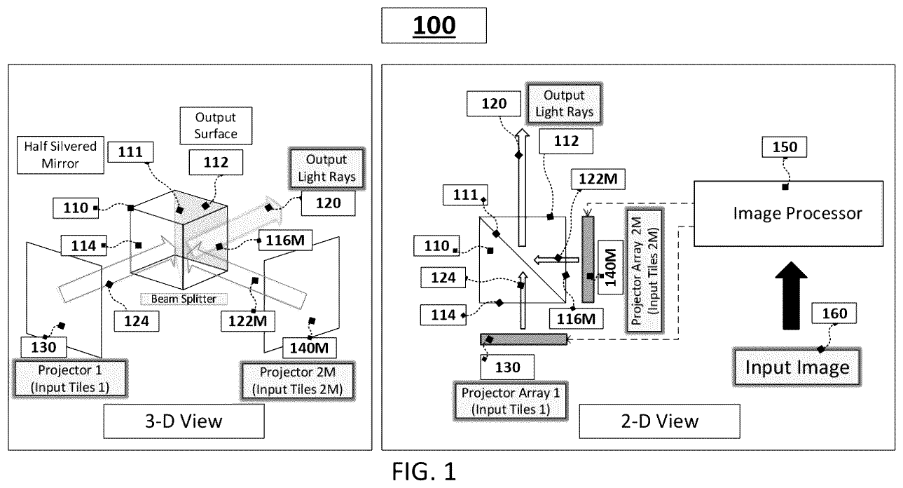

FIG. 1 shows an overview, including three-dimensional (3D) and two-dimensional (2D) views, respectively, of a tileable projector array 100 in accordance with embodiments herein. This projector system 100 is considered one-dimensional as it just affects tiling in one direction, for instance, horizontally or vertically. It includes a beam splitter 110 along with two projector arrays, i.e., projector array 1 130 and projector array 2M 140M (where “M” =mirrored image). The projector arrays can be 1D or 2D.

Projector array 1 (130) creates light rays 124 and projector array 2M 140M creates light rays 122M. Light rays 124 enter surface 114 and pass through half silvered mirror layer 111 and light rays 122M enter surface 116M and are reflected from 111 to create “composite” or combined light rays 120. Additionally, focusing options, such as a lens(es), filter(s) and/or collimator(s), may be provided to shape the light rays 122M from 140M, 124 from 130 and 120 from surface 112.

Input image 160 is split by image processor 150 into a plurality of sub-images for projection by projector elements/tiled of the projector arrays 1 (130) and 2M (140M). Projector array 1 (130) creates light rays 124 which enter beam splitter 110 at surface 114. Projector array 2M (140M) creates light rays 122M which enter beam splitter 110 at surface 116M. Light rays 124 and 122M form composite image light rays 120 to create a composite output image.

Each of the projector arrays is formed of multiple projector elements in a spaced apart relationship. They may be light emitting diode (LED), or organic LED (OLED), or other pixel light generation technology. The pixels should have adequate and sufficient resolution to project an image, preferably, with high definition and fidelity. The projector elements may be configured to project images in monochrome, black-and-white and/or color. The light from the projector arrays can be (1) white light; (2) red, blue, green (RGB) light; or (3) different wavelengths of light. They may support high-resolution, typically defined as 300 or more pixels per inch, projection, such as Standard Definition (SD), i.e., 640×480, High Definition (HD), i.e., 1280×720, Full High Definition (FHD), i.e., 1920×1080; 4K Ultra-high-definition television (UHDTV), i.e., 3840×2160; 8K UHDTV, i.e., 7680×4320 and IMAX®, i.e., 12,000×12,000, as non-limiting resolution examples.

Various compact display modules can be used as the projector elements according to non-limiting embodiments. For example, see the 0.49″ 1920×1080 90 Hz Micro OLEDOS—MIPI and 1.03″ 2560×2560 90 Hz Micro OLEDOS-MIPI modules available at https://www.displaymodule.com/ These display panels are active matrix color Organic Light Emitted Diode (OLED) compact modules based on single-crystal silicon transistors. They integrate a panel driver and a logic driver, to realizes small size, light weight, low power consumption and high resolution.

The pixel data may be 1-D or 2-D depending on the image projector arrangements, although, we note that 2D tiling provides greater use for more applications. We use the terms “tile” and “tiles” herein to refer to projector elements of and/or sub-images projected by the array projectors depending on the context.

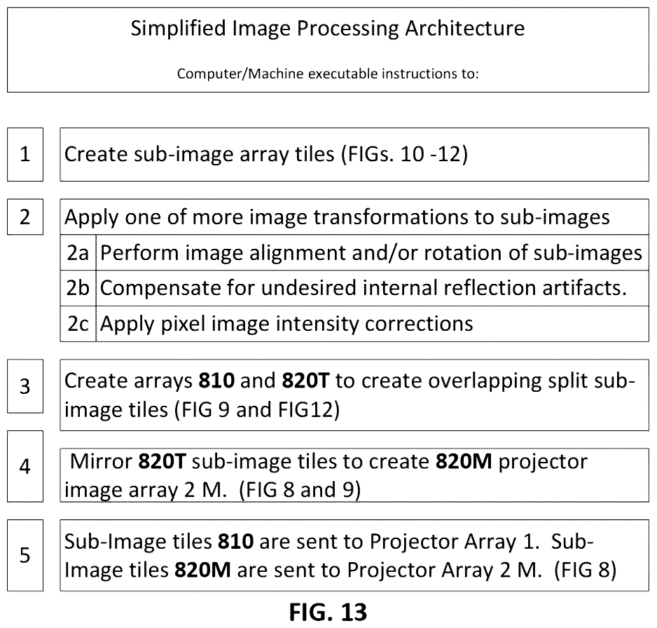

Image processor 150 processes input image 160 to generate sub-images to be projected by the individual projector elements of the first and second projector arrays 1 (130) and 2M (140M) which we refer to as projector image tiles 140M and 130. Ideally, we provide some overlap (e.g., up to 20%) in the sub-images to compensate for optical inconsistencies in tileable projector array 100. Here, image processor 150 splits the input image to create projector sub-images to be projected by the projector elements/tiles. This can occur digitally. If there is overlap between projector tile images, we calculate pixel intensities for overlapping sub-image regions so the overlapping pixel intensities sum together to create a substantially seamless composite image. We describe the specific processing performed by the image processor 150 in greater detail later (see, e.g., FIG. 13).

The processor 150 may be one or more of, or combinations thereof, microprocessors, microcontrollers, field-programmable gate arrays (FPGAs), application specific integrated circuits (ASICs), and/or the like, which are configured to execute machine- or computer-readable instruction (code), stored in non-transitory memory, to implement image processing in accordance with embodiments herein. The methods and algorithm disclosed herein may be implemented and executed by an application created using any number of programming routines. Of course, any number of hardware implementations, programming languages, and operating platforms may be used without departing from the spirit or scope of the invention. As such, the description or recitation of any specific hardware implementation, programming language, and operating platform herein is exemplary only and should not be viewed as limiting.

The input image 160 can be still images or videos (multi-image frames), for example, JPEG (Joint Photographic Experts Group), PNG (Portable Network Graphics), GIF (Graphics Interchange Format), TIFF (Tag Image File Format), and BMP (Windows' bitmap) still image files, and MP4 (MPEG-4 Part 14), AVI (Audio Video Interleave), MOV (Apple's Video Standard), MKV (High-Quality Video Container) and WebM (Optimized for the Web), for video files, as non-limiting examples.

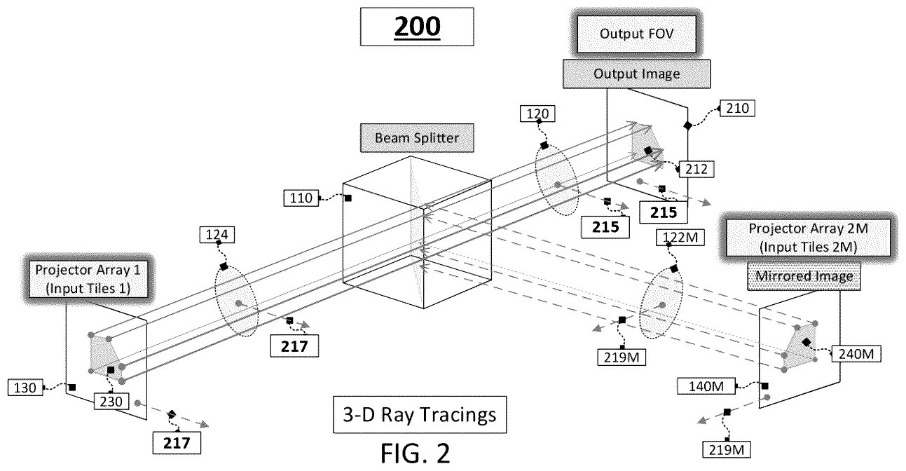

FIG. 2 provides a 3-dimensional view 200 of the single beam splitter 110 of the projector arrays for 100. Input image 160 is converted by image processor 150 into projector arrays 140M and 130. Projector array 1 image plane 130 with horizontal direction vector 217 creates sub-image 230 forming light rays 124 with horizontal direction vector 217. Projector array 2 image plane 140M with direction vector 219M creates mirrored sub-image 240M to form light rays 122M with direction vector 219M. Light rays 124 and 122M are combined together in beam splitter 110 to create composite light rays 120 with direction vector 215 to form composite image 212 on image plane 210.

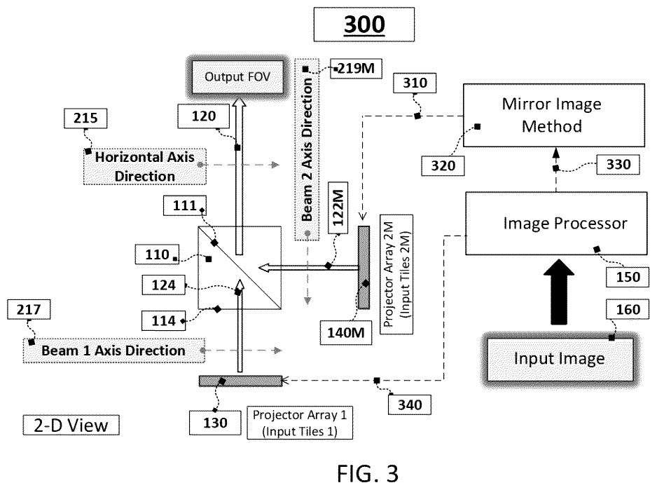

FIG. 3 presents a 2-dimensional view of a projector array 300 in accordance with embodiments herein. Input image 160 is split by image processor 150 into sub-images and mirror method 320 uses sub-images 330 to create projector array 2M 140M from mirror method output 310 and projector array 130 from sub-image 340. Beam splitter 110 combines light from each of the projector array 1 (130) and projector array 2M (140M) to create composite light rays 120 (also see FIG. 2).

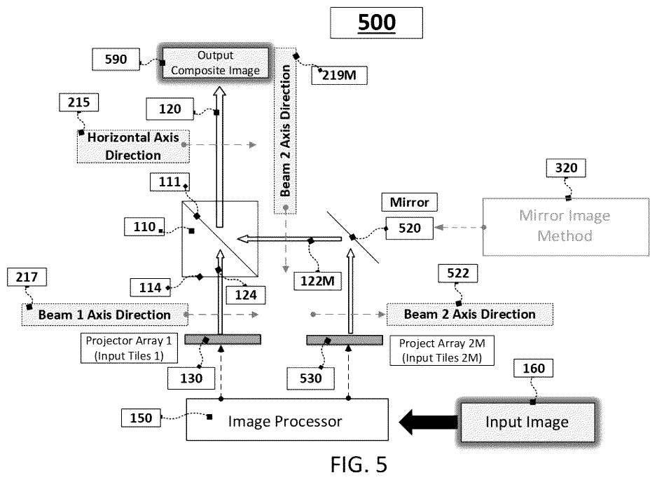

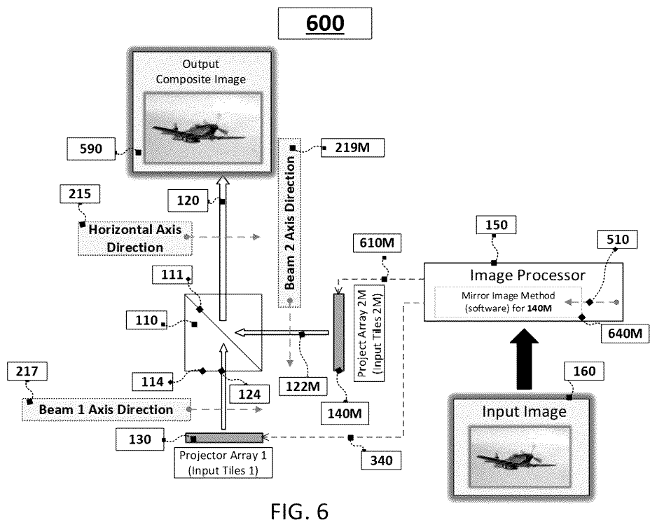

When light rays 112M from projector 2 140M are reflected by the half-silvered mirror layer 111 of the beam splitter 110 they will become mirrored. On the other hand, light rays 124 from projector 1 130 pass through the half-silvered internal mirror 111 unmirrored. This presents a problem for combining the light rays to form the composite image as the reflected light rays 112M and light rays 124 will be in different orientations with respect to one another. Thus, in accordance with embodiments of the invention, the mirrored images will need to be addressed. Thus, we present mirror imaging method(s) 320 to do so. In some embodiments, the mirror imaging method(s) 310 interfaces directly with and affects the beam 122M after being projected by the projector element 140M but prior to entering the surface 116M of the beam splitter 110. This option is denoted as 310. The mirror imaging method(s) 320 may be a mirror (see FIG. 5). In other embodiments, the mirror imaging method(s) 320 interfaces and processes the mirrored sub-image projected by projector array 140M which may be computed by image processor 150. This option is denoted as 610M in FIG. 6. The mirror imaging method(s) 320 may be implemented via image processing which electronically/digitally mirrors the image (see FIG. 6).

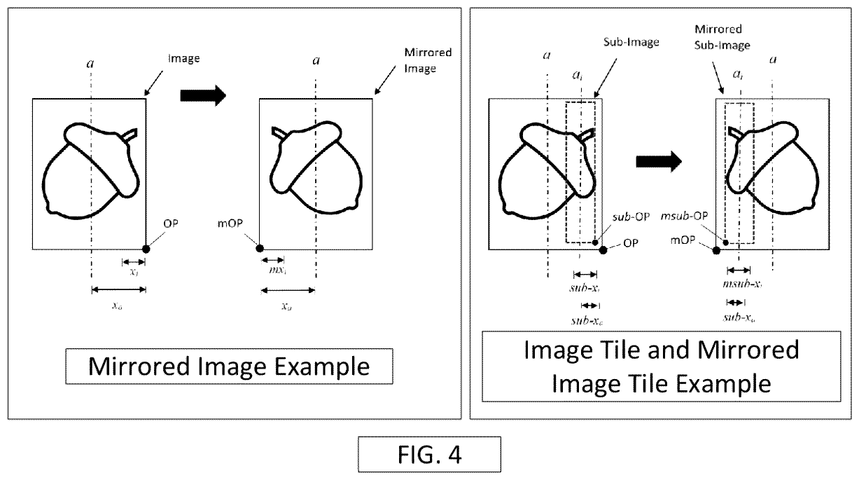

FIG. 4 illustrates how an image is mirrored. To “mirror,” the mirror (see FIG. 5) or mirroring method (see FIG. 6), “flips” or “reverses” the pixels of the image about an axis (typically, the mid-point vertical z-axis) as if the image is viewed in a mirror. Thus, pixels to the right become the pixels to the left and vice-versa in the mirrored image. Each of the second images from the second projector array elements will need to be mirrored (or flipped) so that it will be in the same orientation as the first images from the first projector array elements. Mirroring can be performed using an actual mirror or a digital mirroring algorithm. One exemplary digital mirroring algorithm of the type which could be used is available at: https://imageproedit.com/mirror-image-online.html; it is incorporated by reference in its entirety. The mirrored second images are essentially the same as the first images, and their positions are essentially the same.

As shown in the left image of FIG. 4, mirroring takes the image and flips into about a mirror axis. The mirror axis a is generally taken to be middle point of the field of view (FOV) in the horizontal or x-direction. Mirroring can be accomplished with simple formulae. In the horizontal or x-direction, we take the difference in distance from a given location point xᵢ to the mirror axis a, and either add it or subtract that value the distance xₐ to the mirror axis a as measured from the original point OP. This effectively flips the image in a symmetric manner about the mirror axis a to produce a mirrored image. This can be written as:

if xᵢ<xₐ, then xₘ=(xₐ−xᵢ)+xₐ, or (1)

if xᵢ≥xₐ, then xₘ=(xᵢ−xₐ)−xₐ

The corresponding position in the vertical y-direction does not change; thus yₘ=yᵢ (1a). We denote the mirrored features with an m preceding the prior, corresponding element. This references the second projector array data to the new origin point mOP on the left side.

There is a symmetry between the original images and mirrored images. And the symmetry exists between sub-image(s) of the original images and mirrored sub-image(s). This is shown in the right image of FIG. 4.

We denote the origin position of a sub-image as sub-OP. We used the bottom left edge as one possibility. Its distance from the origin position OP of the field of view (FOV) is determined by a projector element's placement in the second projector array. The origin point of the mirrored sub-image msub-OP is determined using equations (1) and (1a). Knowing the origin position of the sub-image(s) sub-OP, the locations of the pixels in the sub-image sub-xᵢ can be mirrored about its own axis (midpoint) sub-xₐ. Mirrored pixels in the sub-image msub-xₘ can be mirrored as follows:

if sub-xᵢ<sub-xₐ, then msub-xₘ=(sub-xₐ−sub-xᵢ)+sub-xₐ, or (2)

if sub-xᵢ≥sub-xₐ, then msub-xₘ=(sub-xᵢ−sub-xₐ)−sub-xₐ,

The corresponding pixel positions in the vertical y-direction do not change; thus yₘ=yᵢ (2a). This is repeated for all pixels in the sub-image. And the process is repeated for additional sub-images.

FIG. 5 illustrates a tileable projector array image 500 in accordance with embodiments herein. It includes an optical mirror 520 (mirror method 320 in FIG. 3) to correct for the mirrored image caused by light rays 112M being reflected by the half-silvered mirror layer 111 of the beam splitter 110. Mirror 520 may be a fully reflective mirror element, position at a 45° angle. Horizontal axis 522 is parallel to horizontal axis 215 (output image). Image processor 150 calculates overlapping sub-images of the projector arrays 130 and 530. Beam splitter 110 combines light rays 124 and 122M to create composite output image 590. With light rays 122M from projector array 2M being initially reflected by mirror 520 and reflected again by the half-silvered mirror layer 111 of the beam splitter 110, they will be in the same orientation as light rays 124 from the projector array 1 to form the output composite image 590.

FIG. 6 illustrates a tileable projector array 600 in accordance with embodiments herein. Image processor 150 calculates mirrored sub-image 610M using mirror method 640M for projector array 2M (140M) and sub-image 340 for projector array 1 (130). Projector 1 creates light rays 124 and projector array 2M creates light rays 122M. Light rays 124 and 122M form composite light rays 120 inside beam splitter 110 to create composite image 590. Thus, light rays 112M from projector 2, corresponding to the mirrored sub-image 610M, will be reflected by the half-silvered mirror layer 111 in the beam splitter 110 to be in the same orientation as light rays 124 from the projector array 1 to form the output composite image 590.

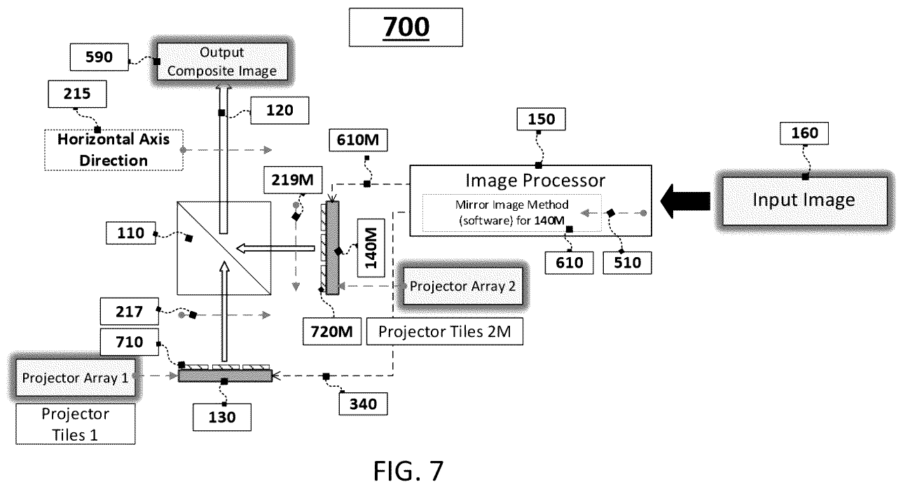

FIG. 7 illustrate a tileable projector array 700 in accordance with embodiments herein. It shows projector array 1 (130) array tiles 710 and mirrored projector array 2M (140M) tiles 720M respectively. For example, the projector arrays may be an array of 3×1 projector elements, an array of 6×1 projector elements, or an array of 8×1 projector elements. (More generically, we note the 1D projector arrays as an array of N×1 projector elements, where N is an integer greater than or equal to 1). Image processor 150 converts the input image 160 into projector array tiles 710 and 720M (mirrored image) to create a projected composite image 590.

For the 1-projector element per projector array embodiments, in a 1D arrangement, there will be 2 projector elements total from two projector arrays positioned on two sides of a single beam splitter to project 2 sub-images. These embodiments thus minimally split up the input image. Nonetheless, they enable the projector elements to be half of the size compared to conventional 1-piece projector elements. Greater size reduction for the projectors can be achieved by having more projector elements per projector array.

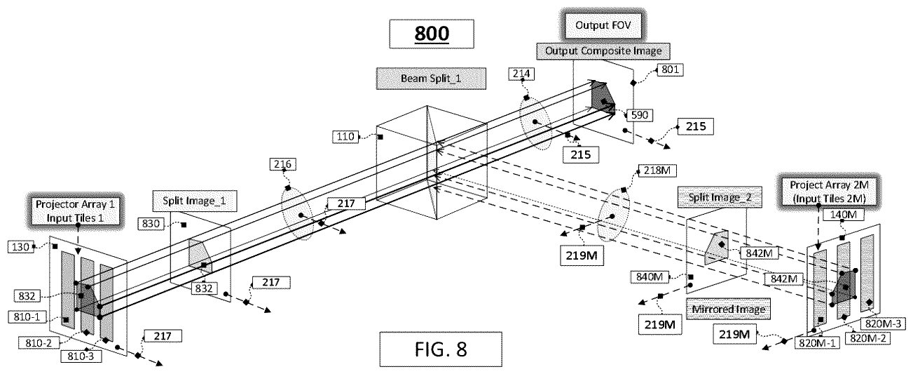

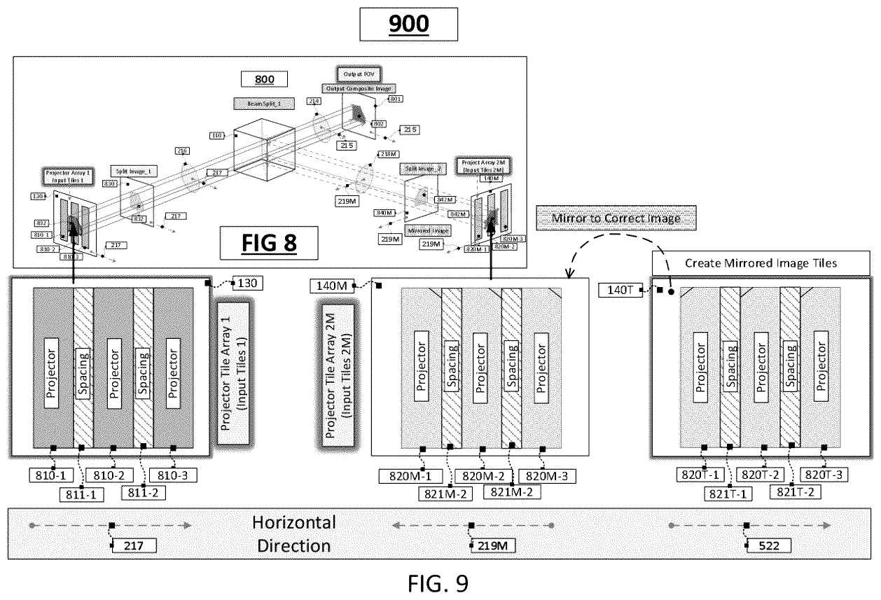

FIG. 8 shows a tileable projector array 800 in accordance with embodiments herein. It shows array projector tiles 810-1, 810-2, and 810-3 on image FOV-1 plane 130 with horizontal direction vector 217. These are 3×1 image projector arrays shown in FIG. 8. Image processor 150 calculates sub-images for projector tile array 130 with tiles 810-1, 810-2, and 810-3 and projector tile array 2M with tiles 820M-1, 820M-2, and 820M-3. Projector array 2M tiles 820M forms image 842M with direction vector 219M and light rays 218M. Projector array 1 tiles 810 forms image 832 with direction vector 217 and light rays 216. Beam splitter 110 mirrors light rays 218M and direction vector 219M. Light rays 216 and mirrored 218M combine in beam splitter 110 to form composite light rays 214 which creates output composite image 590 on image plane 801 with direction vectors 215.

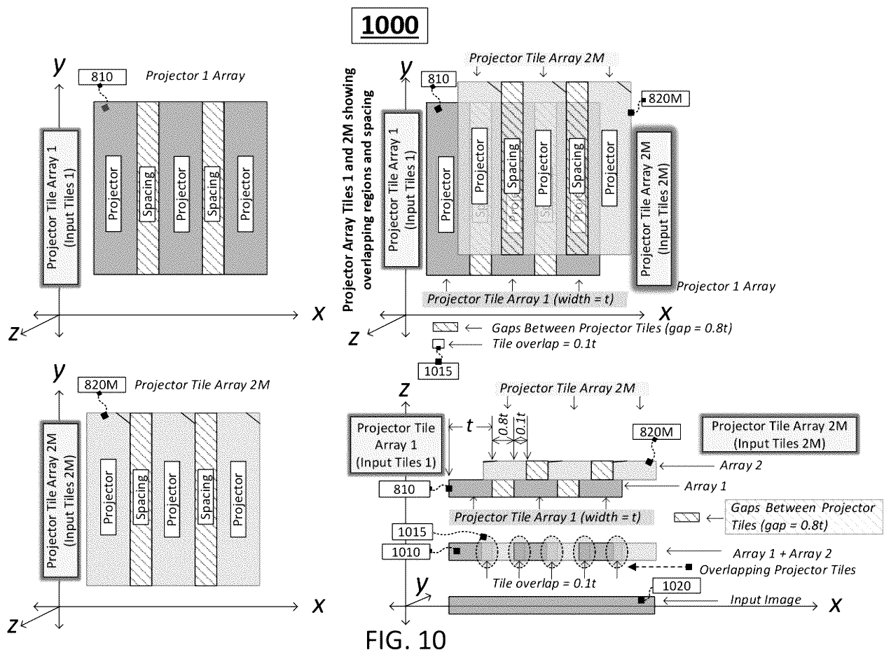

FIG. 9 better illustrates the projector elements (tiles). Projector array 1 (810) has spacings 811 (811-1, 811-2) between adjacent projector elements 810-1, 810-2, 810-3. Projector array 2 (820M) has spacings 821M (821M-1, 821M-2) between adjacent projector elements 820M (820M-1, 820M-2, 820M-3). Image processor 150 calculates the mirrored image of digital image tiles 820T to determine mirrored image projector tiles 2M (820M), if using digital mirror imaging method (see FIG. 3: 320 and FIG. 6). FIG. 8 illustrates the operation of projector array tiles 1 (810) and 2M (820M). To form the composite image 590, the positions of the projector array tiles are offset (or shifted) so that their images fill the spaces between the other projector tile images as shown in FIG. 10. In order to ensure continuous coverage, there may be some overlap between the images of the shifted second projector tiles (820M) and images of the first projector tiles (810). This overlap may be up to 20% between adjacent first and second images in the composite image. Higher overlap is possible; however, we believe the practical upper limit is about 10-20%.

We note that if using a physical mirror to mirror sub-images projected by projector array 2M (820M) (see FIG. 3: 310 and FIG. 5), then locations of the projector elements of array 820M of projector array 2M would be different.

In designing the projector arrays and positioning the projector elements (tiles) therein, we note that it may be easier backwards, that is, to work with mirrored data, to define the positions of the tiles in the first projector array and the mirrored second projector array. The positions of the projector tiles in the mirrored second image array should generally correspond to the position of gaps and/or spaces in the mirrored first projector array. Depending on the design, the image projector may (or may not) correspond to locations where there is no projector element (tile) coverage in the field of views (FOVs). From there, the sub-images 820T (not mirrored) tiles are mirrored to create sub-images to be projected by the projector array 2M tiles 820M. The beam splitter 110 mirrors the mirrored sub-images projected by projector array tiles 820M; thereby, correcting for the mirrored sub-images 820M. Beam splitter 110 combines projector sub-images 810 and mirrored sub-images 820M into an output composite image 590.

FIG. 10 shows how sub-images projected by projector array 1 (130) tiles 810 and projector array 2M tiles (820M) overlap to create a composite image 590. The projector arrays include three identical and spaced apart individual projector elements/tiles arranged in a horizontal direction. The projector elements/tiles each have a length/height and a width t. The gap between adjacent projector tiles is a distance not exceeding the width t of the tiles. (If the projector tiles were oriented in the vertical direction, distance s should not exceed the length of the element). If between projector tiles equals the width of a tile, then there will be no overlap in the coverage of adjacent projector tiles. This option, however, does not provide much tolerance in coverage and may lead to missing areas in the output composite image. On the other hand, if the gap is less than the width of the projector tile, t, then there will be a slight overlap in the images of adjacent first and second projector tiles to better handle inaccuracies in tile alignment tolerances. We chose spacing between projector tiles to be 0.8t, for example. This provides a tile overlap of 0.1t (10%) 1015. Total projector tile width is 0.1t (overlap)+0.8t (gap)+0.1t (overlap)=1t. Composite output image is formed by combining the images of tiles 810 and 820M optically using the beam splitter 110. FIG. 10 illustrates stacking projector tiles 810 and 820M using a 0.1t offset from the gaps between projector tiles to create a composite image.

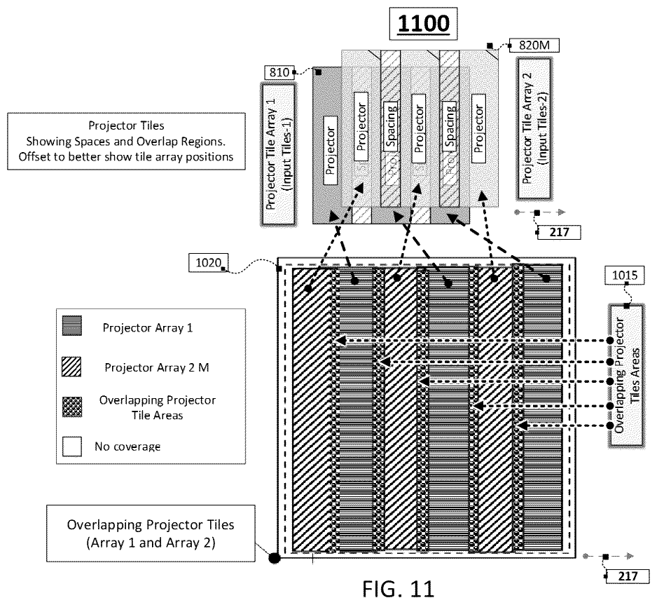

FIG. 11 illustrates the sub-images projected by tiles 810 and 820M, as they are stacked to form the composite image. Gaps between the projector tiles and overlapping projector sub-images are shown. Projector tiles 810 and 820M completely correspond to the input image 1020 to create output composite image 590. There are no areas missing from the output composite image 590.

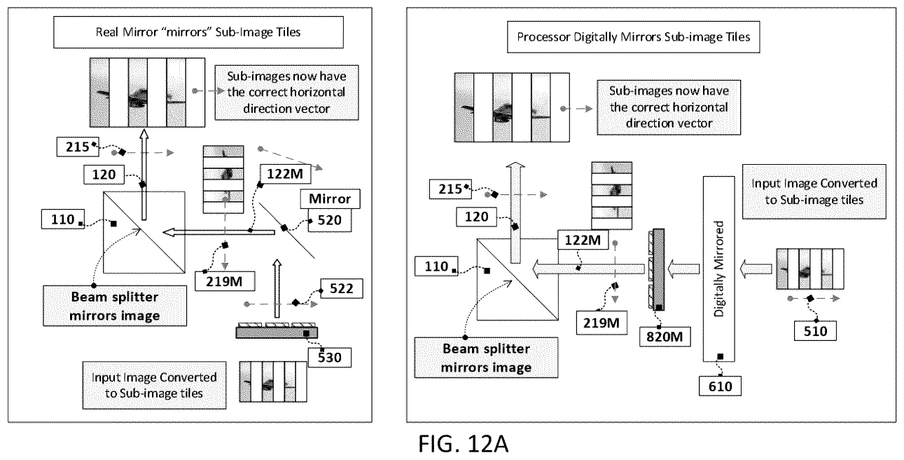

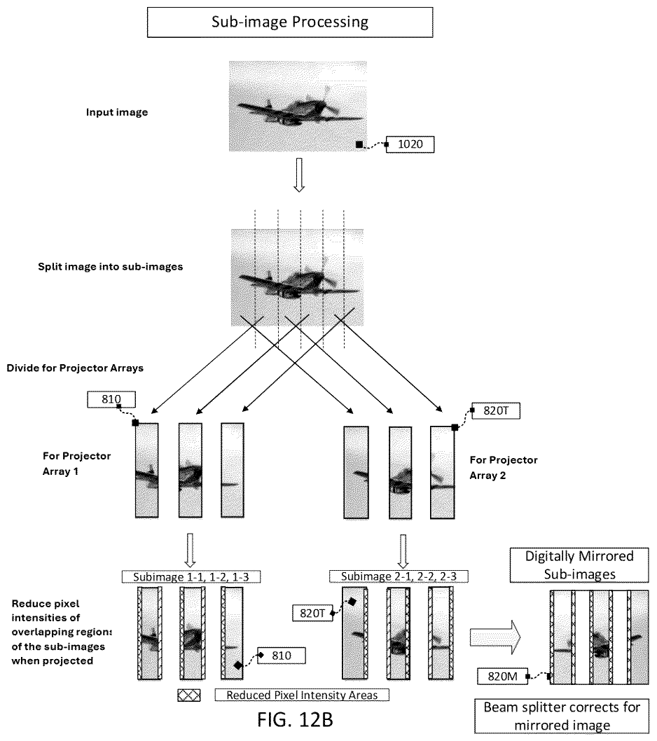

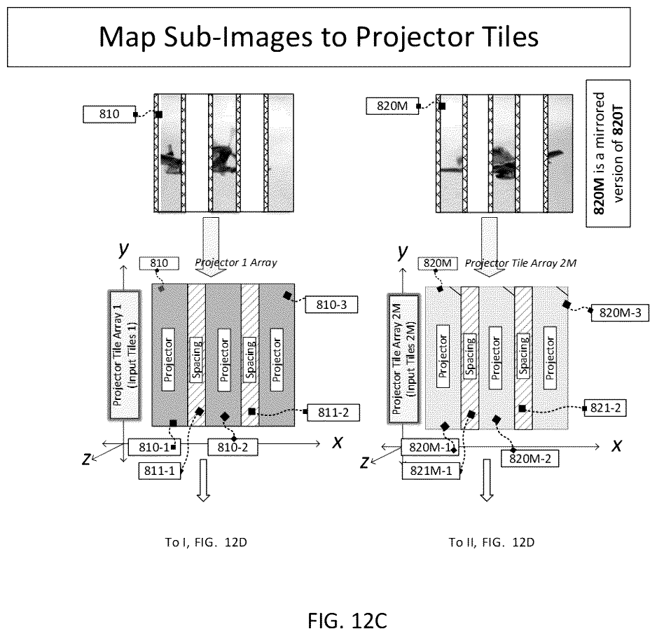

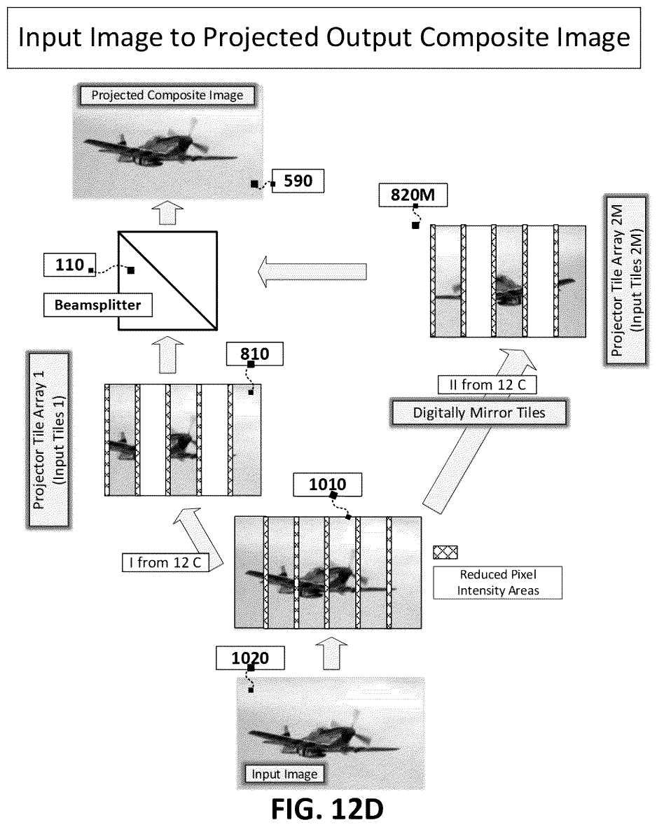

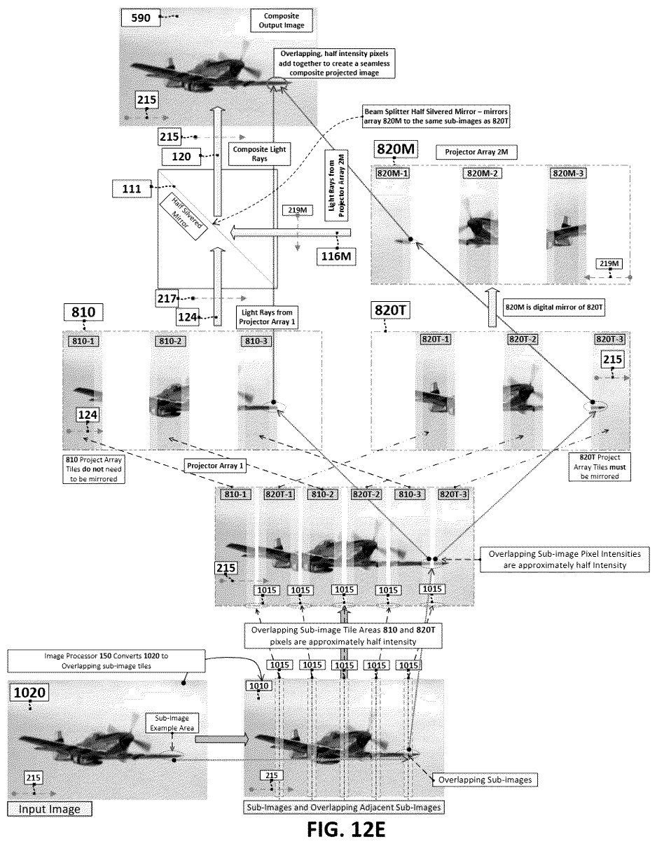

FIGS. 12A-12D show an example of the present invention of splitting an input digital image 1020 into sub-images to be projected by projector arrays 810 and 820M in order to create an output composite image 590. The image processor 150 generates sub-images of the input digital image 1020 for which to project from the projector elements of the first and second projector arrays, respectively. It does so, when those sub-images are projected and optically combined with the beam splitter 110 form the output composite image 590 which substantially corresponding to the input image 1020.

FIGS. 12A-12D show a projector array example with two arrays of 3×1 projector elements (6 total projector tiles). Input image 1020 is first split into sub-images 810 and sub-images 820T. The 810 sub-images are not mirrored. The 810 sub-images are the same as the 810 projector array tiles. Here, the image processor 150 splits the input image 1020 up into 6 overlapping sub-images (corresponding to the number of projector elements total, i.e., 3 and 3). Processor 150 digitally mirrors sub-images 820T to create mirrored projector tiles 820M. Next, the sub-images are divided and transmitted to the various projector elements (tiles) of Projector Array 1 810 and Projector Array 2M 820M (mirrored 820T). Alternating sub-images from the input image 1020 are (or will be) sent to each of the projector tiles in Array 1 810 and Projector Array 2M 820M. The image processor 150 must take into account the locations of the projector elements, by factoring in the mirroring means, i.e., physical mirror or electronic/digital mirroring algorithm. In the latter case, sub-images 820T are digitally mirrored to create sub-images to be projected by projector tiles 820M. Beam splitter 110 then combines the images from projector tiles 810 and 820M into an output composite image 590. Because of this, the regions of the sub-images which will have overlapping pixel intensities should be reduced (or mottled) by half so that when they sum together, they produce a substantially seamless composite image. There is a slight overlap in sub-images projected by the projector tiles 810 and 820M. (But this need not always be the case.).

In the previously described embodiments in FIGS. 12A-12D, we showed using the positions of the projector elements in the first and second projector arrays to introduce a slight overlap of the projected sub-images in the composite image. In FIG. 12E, we show an alternative technique for ensuring overlapping of sub-images in the projected composite output image. We do so by digitally introducing an overlap into the adjacent sub-images themselves so that when projected by the projector elements in the projector arrays, they produce the composite image.

The input image 1020 is split into 6 sub-images along dimension 215 (e.g., 3 for the projector array 810 and 3 for the second projector array 820). Rather than make a single cut line to form adjacent sub-images (as in FIG. 12B), we take additional pixels from the adjacent sub-image(s) (e.g. up to 10% from the ordinary cut line, to provide up to 20% area of overlap) and add them to the current sub-image. As such, adjacent sub-images will contain overlapping regions. These overlapping regions will ultimately combine in the projected composite output image. The brightness of the overlapping regions must be reconciled though. For instance, pixel intensities in the overlapping sub-image regions should be reduced (or mottled) by half so that when they sum together, they produce a substantially seamless composite image. Sub-image color correction, commonly known, might also be applied too in an analogous manner.

Alternating sub-images are separated and will be transmitted to the various projector elements of the projector arrays. Here, sub-images 810-1, 810-2, 810-3 can go directly to the projector elements/tiles of first projector array 1. Sub-images 820T-1, 820T-2, 820T-3 will have to be mirrored (whether by a physical mirror or digital means) to ensure that they are of the same orientation as the sub-images 810-1, 810-2, 810-3 after being reflected by the half-silvered internal mirror 111 and exiting the beam splitter. Here, we use a digital technique to mirror the sub-images 820T-1, 820T-2, 820T-3 across the FOV to form mirrored sub-images 820M-1, 820M-2, 820M-3 to coincide with the projector elements/tiles of second projector array 2M. Care should be taken to assemble the beam splitters and projector arrays to ensure properly alignment of the projector elements/tiles with the composite output image 590.

The first sub-images 810-1, 810-2, 810-3 projected by projector elements of the first projector array 1 enter the beam splitter as light 124 along beam axis direction 217. And the mirrored sub-images 820M-1, 820M-2, 820M-3 projected by projector elements of the second projector array 1 enter the beam splitter as light 116M along beam axis direction 219M. Light 124 passes through the half-silvered internal mirror 111 and light 116M reflects on the half-silvered internal mirror 111 to combine as light 120 to produce the composite output image 590. The same technique can be used for 2D embodiments.

In the previously described embodiments, we showed using the positions of the projector elements in the first and second projector arrays to introduce a slight overlap of the projected sub-images in the composite image. In FIG. 12E, we show an alternative technique for ensuring overlapping of sub-images in the projected composite output image. We do so by digitally introducing an overlap 1015 into the adjacent sub-images 810 and 820T so that when projected by the projector elements in the projector arrays 810 and 820M, they produce the composite image 590.

The image processing steps, implemented by the image processor 150 to create the composite image 590 in FIGS. 12A-12E, are summarized in FIG. 13. We assume the implementation of the tileable projector array 800 and 900 makes use of electronically/digitally mirroring means 140M/610M to mirror the sub-images 820T to be projected by tiles of the projector array 2M 820M.

In FIG. 13 step 1, image processor 150 creates sub-image 810 and 820T by splitting the input image 1020 for projecting with the various projector element/tiles. For instance, the image is split into equally sized sub-images corresponding to the total number of projector elements/tiles in the tileable array projector.

In step 2, correction transformations are applied to convert the raw sub-image 810 and 820T into sub-images for projecting via the projector array 1 (710/810) and projector tile 2M (720M/820M). For step 2 in FIG. 13, the digital sub-images are further processed. The projector tiles slightly overlap and may be misaligned in position (x, y, z), and rotation angle (α, β, γ) which need correcting. The sub-images are transformed to compensate for position errors, rotation errors, and overlapping projector tile positions. The projector array corrections are calculated by analysis sub-image data and/or calibration data. When merging two sub-images any inconsistency along their border can be very visible. Various techniques to blend the overlapping regions have been developed to accomplish this. These can be applied in step 2. Small geometric distortions must be harmonized across all sub-images, correcting for perspective, skew, etc. For example, consider a large photograph, cut into rectangular pieces. These sub-images are then scattered across an uneven surface. First, all sub-images are assumed to lay on a single flat surface. Following that, they can be rotated and shifted until their edges line up in step 2. Lighting must be even across all the composite image, especially at the edges. When two sub-images meet at a border, a small inequality in brightness can cause the border to be highly visible. Thus, in step 2, the brightness must be reconciled. For instance, the overlapping pixels intensity may be halved. Sub-image color correction, commonly known, might also be applied too in an analogous manner.

In FIG. 13 step 3, the processing can create overlapping sub-images of projected tiles 810 and 820T by a predetermined amount, say 10%. Projector array tiles 1 is the same as sub-image tiles 810. We note similar results can be achieved by digital forming overlapping sub-images (see FIG. 12E).

In FIG. 13 step 4, the processing mirrors sub-images 820T to create sub-images to be projected by projected elements/tiles of projector array 2M (820M).

In FIG. 13 step 5, projector array 1 outputs sub-images 810 and projector array 2M projects via projector tiles 820M. The beam splitter 110 then creates a composite image.

The steps in FIG. 13 can be rearranged and/or run in parallel for various algorithm optimizations.

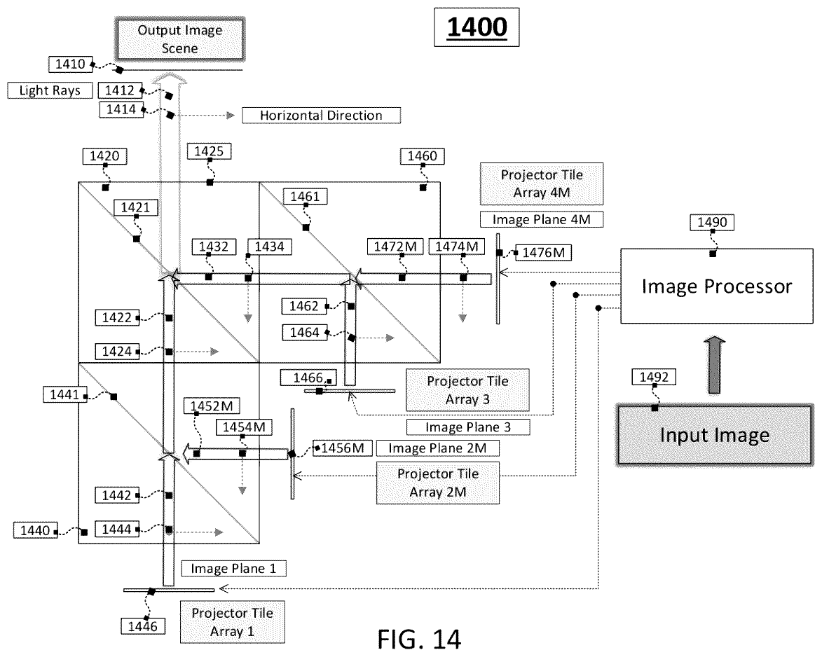

The aforementioned techniques may be expanded to a second dimension. FIG. 14 shows a tileable projector array 1400 in accordance with embodiments of the present invention. It makes use of three beam splitters which create four copies of the digital input image. Due to the 3 beam splitters, the composite output image's intensity is reduced to (¼) of the input intensity of each projector array. However, the final output intensity is N·M·4·(¼)=N·M since there are N×M projector elements/tiles in each projector array where N and M are integers both greater than or equal 1 and there are 4 projector arrays. The projector arrays may be a 2D array of 3×3 projector elements×4 image planes, an array of 6×6 projector elements×4 image planes, or an array of 8×8 projector elements x 4 image planes, for example. (More generically, we note the 2D projector arrays as an array of M×N×4 projector elements (4 image planes), where M and N are integers both greater than or equal to 1).

For the 1-projector element per projector array embodiments, in a 2D arrangement, there will be 4 projector elements total from four projector arrays positioned in a 1×1 arrangement on 2 sides of 2 different beam splitters to project 4 sub-images. These embodiments thus minimally split up the input image. Nonetheless, they enable the projector elements to be quarter of the size compared to conventional 1-piece projector elements. Greater size reduction for the projectors can be achieved by having more projector elements per projector array.

FIG. 14 presents a three-beam splitter version of the present invention. Input digital image 1492 is processed by image processor 1490 for projection with the projector array 1 (1446), 2M (1456M), 3 (1466) and 4M (1476M). Image processor 1490 uses the same general methods as described in FIGS. 8-13 . Projector array 1 creates light rays 1442 with direction 1444. Projector array 2M creates light rays 1452M with direction 1454M. Beam splitter 1440 with half silvered surface 1441 combines rays 1442 and 1454M to create rays 1442 with direction 1424. Beam splitter 1460 with half silvered surface 1461 combines light rays 1472M and 1462 to create light rays 1432 with direction 1434. Beam splitter 1420 with half silvered surface 1421 combines light rays 1422 and 1432 to create light rays 1412 with direction 1414. At image plane 1410, light rays 1412 create a composite output image.

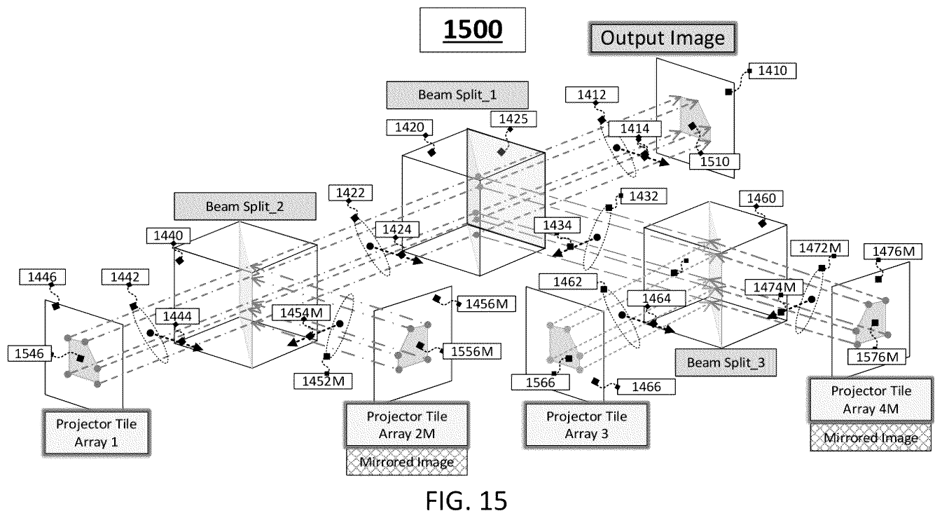

An exploded 3-dimensional view 1500 of the tileable projector array with three beam splitters is presented in FIG. 15. Projector array 1 (1446) with sub-images 1546 creates light rays 1442 with direction 1444. Projector time array 2M (1456M) with sub-images 1556M creates rays 1452M with direction 1454M. Beam splitter 1440 combines light rays 1442 and 1452M to create light rays 1422 with direction 1424. Projector array 3 (1466) with sub-images 1566 creates light rays 1462 with direction 1464. Projector array 4M (1476M) with sub-images 1576M creates rays 1472M with direction 1474M. Beam splitter 1460 combines light rays 1462 and 1472M to create light rays 1432 with direction 1434. Beam splitter 1420 with output surface 1425 combines light rays 1432 and 1422 to create composite light rays 1412 with direction 1414. Light rays 1412 create composite image 1510 on image plane 1410.

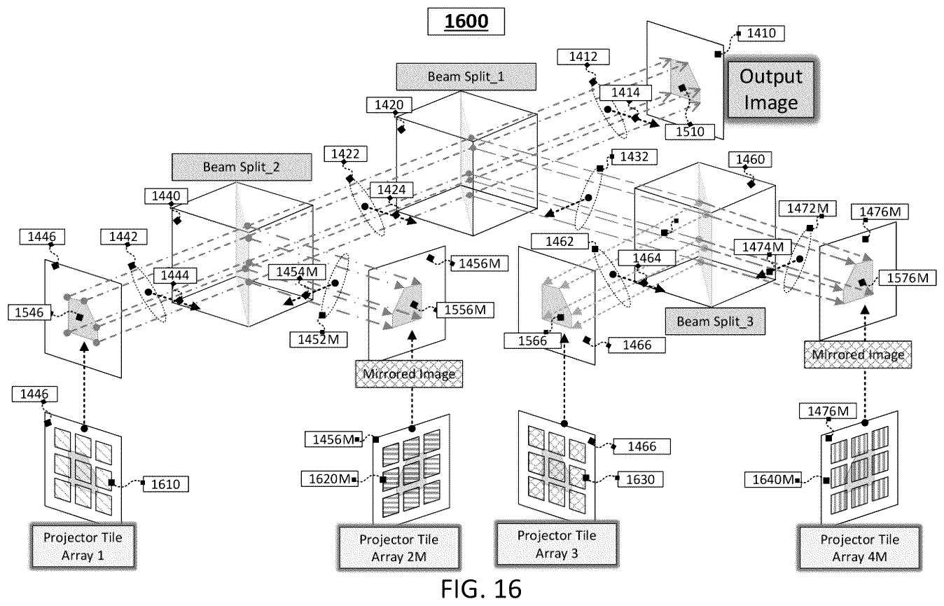

FIG. 16 illustrates the projector array tiles 1 (1610), 2M (1620M), 3 (1630) and 4M (1640M) used to project sub-images 1546, 1556M, 1566, and 1576M respectively to create output composite image 1510. “M” indicates a mirrored image. Mirrored images are computed by image processor 1490.

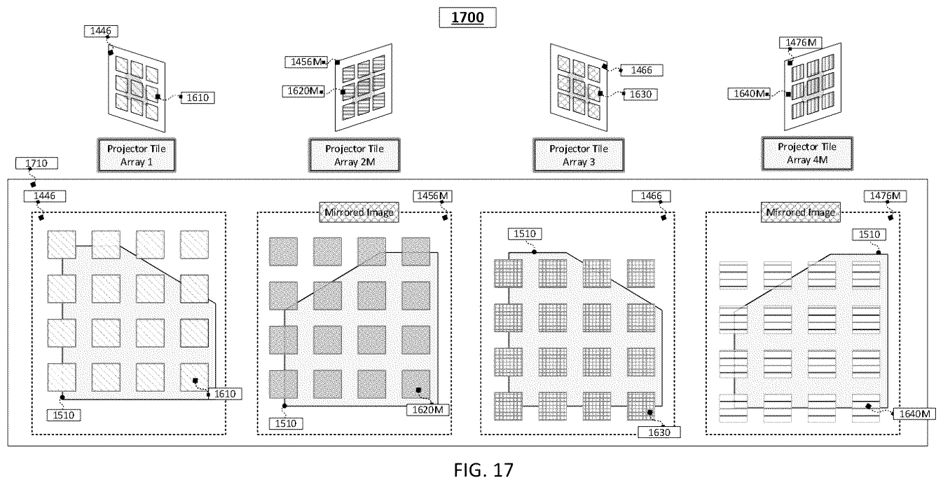

In FIG. 17, the relative positions 1710 of the projector elements/tiles of projector arrays 1 (1610), 2M (1620M), 3 (1630), and 4M (1640M) are shown compared to the output composite image 1510.

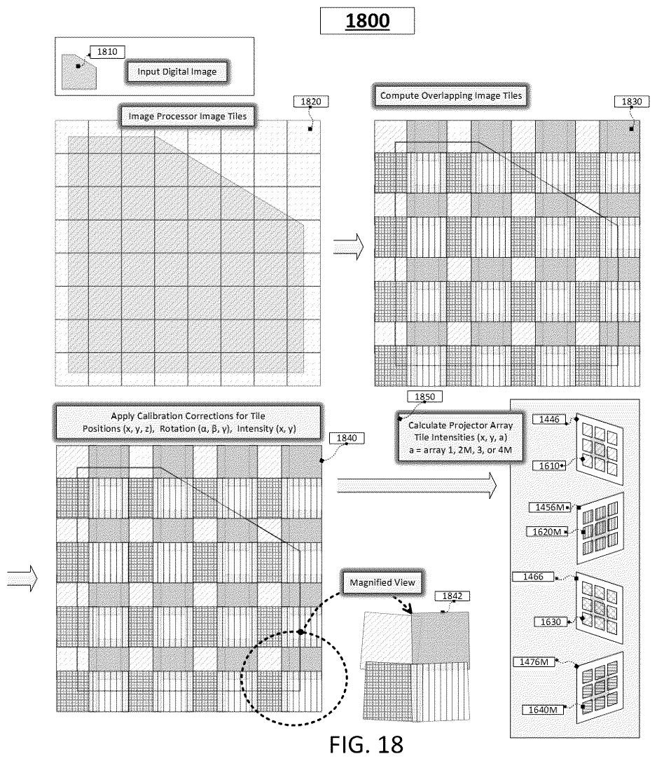

FIG. 18 presents a magnified view showing the overlapping sub-images of projector elements/tiles, and possible misalignment errors (position and rotation) for an example set of projector tiles. Input image 1810 is partitioned into sub-image 1820. Image processor 1490 calculates the overlapping sub-images for projector element/tiles in 1830. Image processor 1490 transforms the sub-images to compensate for position, rotation, and overlapping projector tile areas to calculate the pixel intensities (see 1842 for example) for projector arrays 1 (1610), 2M (1620M), 3 (1630), and 4M (1640M).

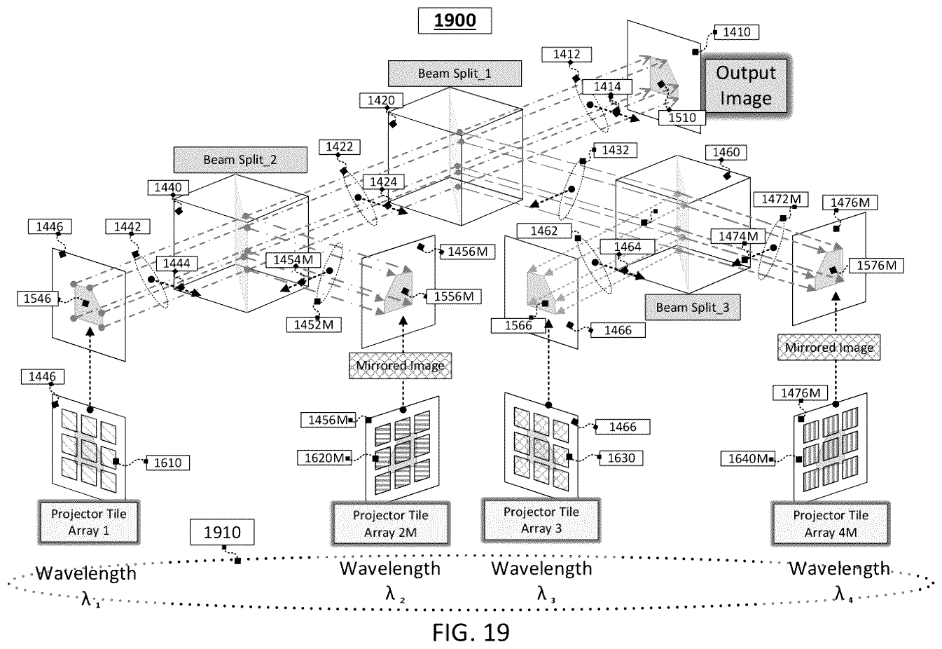

FIG. 19 illustrates a tileable projector array 1900 in accordance with embodiments of the present invention. Here, each projector array 1910 is being used to transmit a different optical wavelength. High resolution infra-red (IR), mid-IR, long-IR and/or THz image scene could be generated using the present invention. Each projector array (1610, 1620M, 1630, and 1640M) can use a different optical wavelength filter to create a hyperspectral imaging system. This could be achieved with the one-dimensional embodiments too. Each sub-image can also have an individual wavelength filter to create a larger hyperspectral imaging projector array.

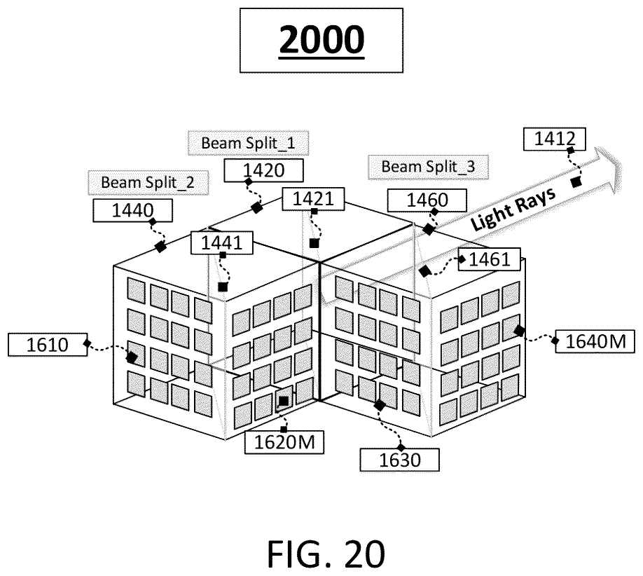

FIG. 20 shows a tileable projector array 2000 in accordance with embodiments of the present invention. It shows an example detailing the relative positions of the projector tiles (1610, 1620M, 1630, and 1640M) for a [(4×4 array)×4 image planes] on the 3-beam splitter assembly 2000. The projector elements are mounted on and/or integrated into a printed circuit board to form the projector elements which are mounted adjacent to the beam splitters. Or the projector elements may simply be attached to the beam splitters using an optical grade glue, for example. Or bonded using other techniques.

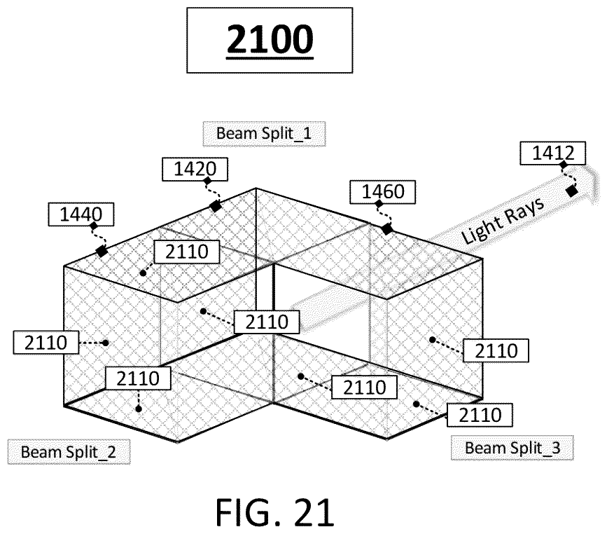

FIG. 21 shows a tileable projector system 2100 in accordance with embodiments of the present invention. It includes three beam splitters 1420, 1440 and 1460. The surfaces 2110 of beam splitters 1420, 1440 and 1460 have anti-reflection coatings and optical baffles to reduce unwanted internal reflections (image ghosting).

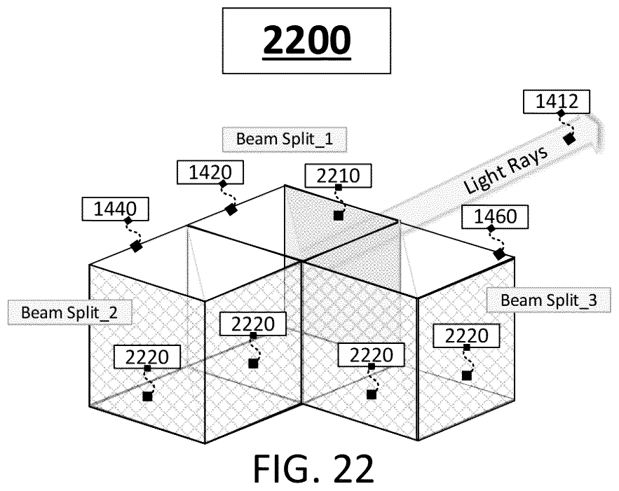

FIG. 22 shows a tileable projection system 2200 in accordance with embodiments of the present invention. It includes anti-reflection coatings and optical baffles 2220 for the projector arrays (1610, 1620M, 1630, and 1640M). Beam splitter 1 (1420)'s light output surface 2210 has an anti-reflection coating and optical baffle to reduce unwanted reflections.

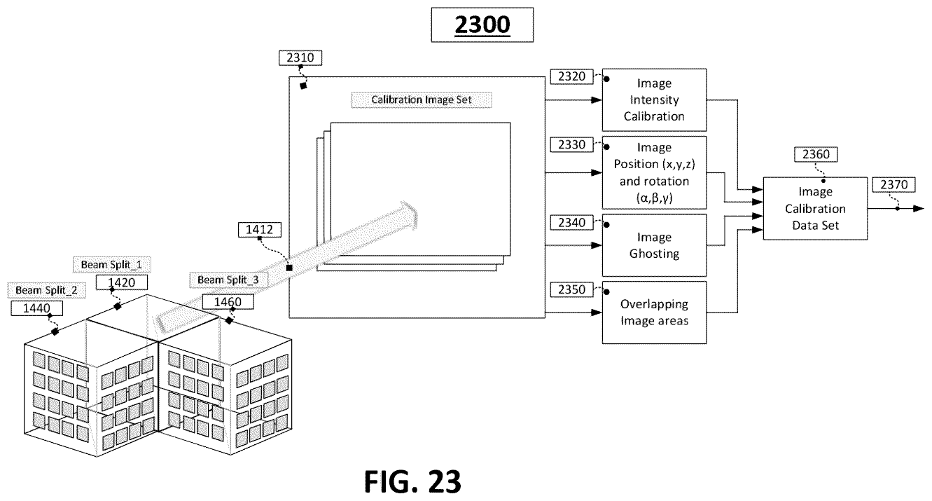

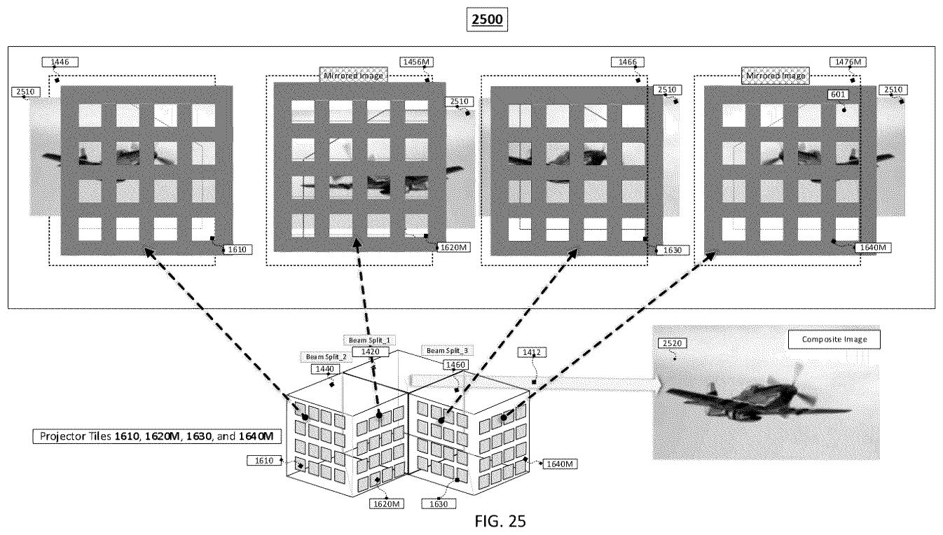

FIG. 23 shows the projection array calibration sets 2300 according to embodiments. A calibration image set 2310 is used to create projector element/tile calibration 2360 data set 2370: (1) projector element/tile intensity calibration data 2320; (2) projector element/tile position (x, y, z) calibration, and rotation (α, β, γ) calibration data 2330; (3) image ghosting calibration data 2340; (4) and overlapping sub-images calibration 2350. Optical assembly 1500 is a rigid structure and is long-term stable. Calibration data can be created during manufacturing of 1500 and stored (e.g., in a memory associated with the processor 1490) to help improve the accuracy and speed up calculations to convert input image to projector element/tiles. Rigid structure 1500 and calibration data 2370 help simplify image transformations to split the input image into sub-images for the element/tiles of the projector arrays. The calibration data 2300 provides optimizations to speed up and simplify image transformations for the projector array tiles in FIG. 25. Or re-calibration may be performed at regular intervals and/or should it become necessary.

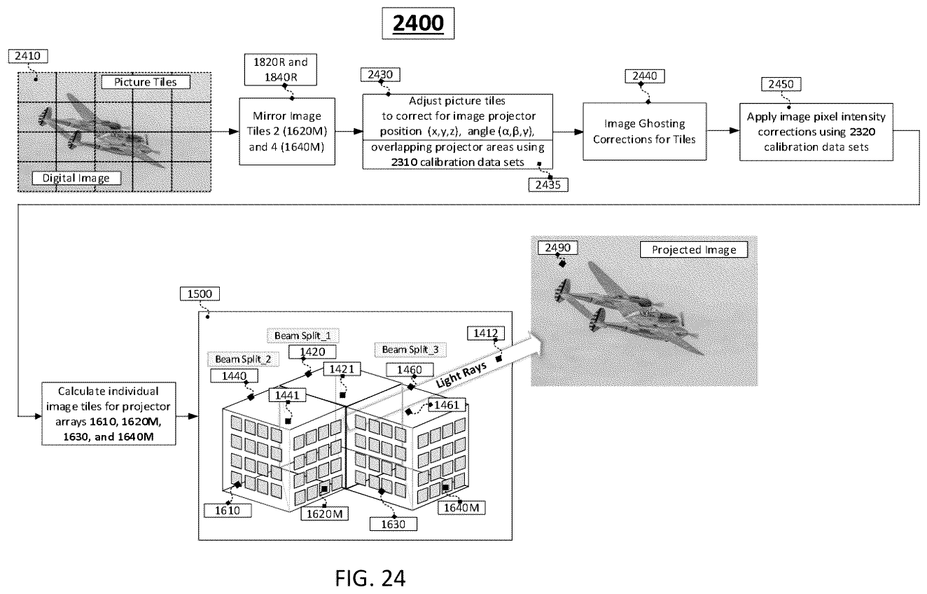

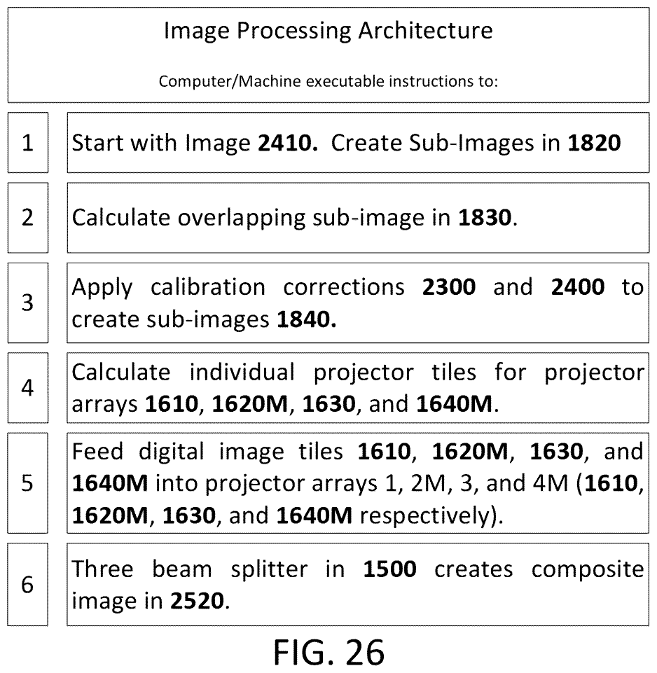

FIG. 24 summarizes the steps to process an input digital image 2410 for projected by projector arrays 1, 2M, 3, and 4M to create a very high-resolution composite output image 2490 using method 2400 according to embodiments. The image processing steps (algorithm) is summarized in FIG. 26 following the steps outlined in FIGS. 14-25 . Image processing steps 1620M and 1640M mirror the sub-image for projector arrays 2M and 4M. Transformations 2430 and 2435 adjust position and rotation alignment errors and overlapping projector tiles. Step 2440 compensates for unwanted internal reflections in 1500. Step 2450 corrects for pixel amplitude errors in the elements/tiles of the projector arrays 1, 2M, 3, and 4M. The digital sub-images are fed to the tiles of the projector arrays attached to three beam splitter 1500. The output rays 1412 create a high-resolution composite output image 2490. The processing steps presented in 2400 are one possible example. Steps in 2400 may be run in parallel and/or in a different ordering.

FIG. 25 highlights the digital sub-image sent to tiles of the projector arrays 1, 2M, 3, and 4M. The sub-images 1610, 1620M, 1630, and 1640M are fed into optical assembly 1500. The projector arrays 1, 2M, 3, and 4M light rays combine in 1500 to create a high-resolution output composite image 2520 from input digital image 2510.

FIG. 26 presents an algorithm for the 3-beam splitter tileable projector in FIGS. 14-25 following the 1D tiling algorithm in FIG. 13.

Step 1, start with input digital image 2410, create sub-images in 1820. Step 2, calculate overlapping sub-images in 1830.

Step 3, apply calibration corrections from 2300 and 2400 (covering positions (x, y, z), angles (α, β, γ), internal reflection (image ghosting) errors, and pixel intensity corrections) of the projector elements/tiles to create corrected sub-images 1840.

Step 4, calculate individual projector tiles for projector arrays 1610, 1620M, 1630, and 1640M.

Step 5, feed digital sub-images 1610, 1620M, 1630, and 1640M into projector arrays 1, 2M, 3, and 4M (1610, 1620M, 1630, and 1640M respectively).

Step 6, the three beam splitters 1500 create composite output image 2520.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g. one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, and to describe the actual partial implementation in the laboratory of the system which was assembled using a combination of existing equipment and equipment that could be readily obtained by the inventors, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A tileable array projector comprising:
a first beam splitter, which receives light from first and second surfaces thereof, respectively, and has a partially-mirrored internal surface which transmits light received from the first surface and reflects light received from the second surface so as to combine their light and to output light to an output surface thereof;
a first projector array of one or more projector elements spaced-apart in a first direction positioned near the first surface of the first beam splitter to project one or more first sub-images of an input image to the first surface of the first beam splitter;
a second projector array of one or more projector elements spaced-apart in the first direction having the second surface of the first beam splitter to project one or more second sub-images of the input image to the second surface of the first beam splitter;
a mirror means to mirror light to, or digitally mirror the one or more second sub-images with respect to, the second surface of the first beam splitter,
wherein positions of the one or more projector elements in the second projector array, factoring in the effect of the mirror means, generally correspond to spaces between or adjacent the one or more projector elements in the first projector array in the first direction when their respective projected sub-images are superimposed and aligned; and
an image processor configured to:
generate the one or more first sub-images and the one or more second sub-images from the input image for which to project from the projector elements of the first and second projector arrays, respectively, so that when projected and combined with the first beam splitter form a composite image substantially corresponding to the input image.
transmit the one or more first sub-images to the one or more projector elements of the first projector array; and
transmit the one or more second sub-images to the one or more projector elements of the second projector array.

2. The projector of claim 1, wherein the projector is a one-dimensional tileable array projector and the first and second projector arrays each comprise: an array of N×1 projector elements, where N is an integer greater than or equal to 1.

3. The projector of claim 1, wherein, for each of first and second projector arrays, the one or more projector elements are identical and spaced apart in the first direction by a distance not exceeding a length/width of the one or more projector elements in the first direction.

4. The projector of claim 1, wherein there is up to 20% overlap in adjacent projected sub-images in the composite image.

5. The projector of claim 4, wherein the overlap in adjacent projected sub-images is produced by positioning the one or more projector elements in the first and second projector arrays so that the projected sub-images overlap when projected to produce the composite image.

6. The projector of claim 4, wherein the overlap in adjacent projected sub-images is produced by a digital technique to introduce an overlap into adjacent sub-images so that the projected overlapping sub-images when projected by the one or more projector elements in the first and second projector arrays produce the composite image.

7. The projector of claim 1, wherein the mirror means comprises (i) a mirror positioned between the second surface of the first beam splitter and the second projector array to reflect the projected light to the second surface of the first beam splitter, or (ii) a processing technique to digitally mirror the one or more second sub-images from the one or more projector elements of the second projector array.

8. The projector of claim 1, wherein the projector is a two-dimensional tileable array projector and the first, second, third and fourth projector arrays each comprise: an array of M×N projector elements, where M and N are integers both greater than or equal to 1.

9. The projector of claim 8, further comprising:
a pair of second beam splitters, the first of the pair positioned near the first surface of the first beam splitter, and the second of the pair positioned near the second surface of the first beam splitter, where each of the pair, receives light from first and second surfaces thereof, respectively, and has a partially-mirrored internal surface which transmits light received from its first surface and reflects light received from its second surface so as to combine their light and to output light from the first and second surfaces of the first beam splitter, respectively;
wherein the projector elements of the first and second projector arrays are spaced-apart in the first direction and a second direction, perpendicular to the first direction, to project the one or more first sub-images and the one or more second sub-images to the first and second surfaces of the first of the pair of second beam splitter;
a third projector array of one or more projector elements spaced-apart in the first direction to project one or more third sub-images of the input image to the first surface of the second of the pair of second beam splitter;
a fourth projector array of one or more projector elements spaced-apart in the second direction to project one or more fourth sub-images of the input image to the second surface of the second of the pair of second beam splitter,
wherein the mirror means also mirrors light to, or digitally mirrors the one or more fourth sub-images;
wherein positions of the one or more projector elements in the second projector array, factoring in the effect of the mirror means, generally correspond to spaces between or adjacent the one or more projector elements in the first projector array in the first and second directions when their respective sub-images are superimposed and aligned;
wherein positions of the one or more projector elements in the fourth projector array, factoring in the effect of the mirror means, generally correspond to spaces between or adjacent the one or more projector elements in the third projector array in the first and second directions when their respective sub-images are superimposed and aligned;
wherein positions of the one or more projector elements in the second projector array, factoring in the effect of the mirror means, generally correspond to spaces between or adjacent the one or more projector elements in the first projector array in the first and second directions when their respective sub-images are superimposed and aligned to project the image;
wherein the positions of the one or more projector elements in the third and fourth projector arrays in the second direction, factoring in the effect of the mirror means, generally correspond to spaces between or adjacent the one or more projector elements in the first and second projectors arrays in the first and second directions, respectively, when their respective sub-images are superimposed and aligned; and
the image processor configured to:
generate one or more first sub-images, one or more second sub-images, one or more third sub-images and one or more fourth sub-images for which to project from the first, second, third and fourth projector arrays, respectively, from the input image so that when projected and combined with the first beam splitter and the pair of second beam splitters form a composite image substantially corresponding to the input image;
transmit the one or more first sub-images to the one or more projector elements of the first projector array;
transmit the one or more second sub-images to the one or more projector elements of the second projector array;
transmit the one or more third sub-images to the one or more projector elements of the third projector array; and
transmit the one or more fourth sub-images to the one or more projector elements of the fourth projector array.

10. The projector of claim 9, wherein the mirroring means comprises: (i) a first mirror positioned between the second surface of the first of the pair of the second beam splitters and the second projector array to reflect the light projected from the second projector array; and a second mirror positioned between the second surface of the second of the pair of the second beam splitter and the fourth projector array to reflect the light projected from the fourth projector array; or (ii) a processing technique to digitally mirror the one or more second sub-images and the one or more fourth sub-images, respectively.

11. The projector of claim 1, wherein the various projector elements are mounted on and/or integrated into a printed circuit board to form the projector arrays.

12. The projector of claim 1, wherein, in each of the projectors arrays, the one or more projector elements are configured to project (1) white light; (2) red, blue, green (RGB) light or (3) different wavelengths of light.

13. The projector of claim 1, further comprising optics for focusing, collimating, and/or filtering light output from the output surface of the first beam splitter.

14. The projector of claim 1, further comprising optic anti-reflection coatings and/or optical baffles on optical components therein to reduce unwanted internal reflections.

15. A method for image tiling using the tileable array projector of claim 1, the method comprising:
generating one or more first sub-images and one or more second sub-images for which to project from the projector elements of the first and second projector arrays, respectively, so that when projected and combined with the first beam splitter form a composite image substantially corresponding to the input image;
transmitting the one or more first sub-images to the one or more projector elements of the first projector array; and
transmitting the one or more second sub-images to the one or more projector elements of the second projector array.

16. The method of claim 15, further comprising: applying pixel intensity reduction to regions of the sub-images which will overlap when projected.

17. A method for image tiling using the tileable array projector of claim 9, the method comprising:
generating one or more first sub-images, one or more second sub-images, one or more third sub-images and one or more fourth sub-images for which to project from the first, second, third and fourth projector arrays, respectively, so that when projected and combined with the first beam splitter form a composite image substantially corresponding to the input image;
transmitting the one or more first sub-images to the one or more projector elements of the first projector array;
transmitting the one or more second sub-images to the one or more projector elements of the second projector array;
transmitting the one or more third sub-images to the one or more projector elements of the third projector array; and
transmitting the one or more fourth sub-images to the one or more projector elements of the fourth projector array.

18. A method for calibrating the tileable array projector of claim 1, the method comprising:
performing projector calibration for the one or more projector elements of each of the projector arrays;
computing projector calibration data set for the tileable array projector to be used for correcting sub-image data with respect to the one or more projector elements of each of the projector arrays.

19. The method of claim 18, further comprising:
correcting the sub-images based on computed projector calibration data.

20. The method of claim 18, wherein performing projector calibration comprises:
determining projector element positional [x-axis, y-axis, and/or z-axis] and rotational [alpha (x-axis), beta (y-axis), and/or gamma (z-axis)] offsets for the optical paths of the one or more projector elements of each of the projector arrays; and
correcting the sub-images comprises applying position and rotation corrections to sub-images to correct for the offsets.

21. The method of claim 18, wherein performing projector calibration comprises analyzed internal reflections for the beam splitters; and correcting the sub-images comprises applying corrections to the sub-images to correct for unwanted beam splitter internal reflections.
